(19) United States
(12) Patent Application Publication
(10) Pub. No.: US 2026/0148125 A1
(43) Pub. Date: May 28, 2026

(54) AD-HOC DATA CLASSIFICATION USING POLICY GRAPHS

(71) Applicant: ADOBE INC., SAN JOSE, CA (US)

(72) Inventors: Siddharth Srinivasan Iyer, San Francisco, CA (US); Xiarui Zhang, San Francisco, CA (US); Anand Khanna, San Jose, CA (US); Chris Campbell, Brentwood, CA (US); Oliver Brdiczka, San Jose, CA (US); Adam Portilla, Port Townsend, WA (US); Alec Helbling, Pittsburgh, PA (US); Shubhika Garg, Pittsburgh, PA (US)

(21) Appl. No.: 18/958,773

(22) Filed: Nov. 25, 2024

(51) Int. Cl. G06N 20/00

(52) U.S. Cl. CPC G06N 20/00

(57) ABSTRACT

A method, apparatus, non-transitory computer readable medium, and system for data classification include obtaining input data and a policy graph. The policy graph includes a decision node indicating a machine learning classifier. Embodiments then generate, using the machine learning classifier, a classification result based on the input data and the decision node. Subsequently, embodiments generate a decision label for the input data based on the classification result.

### BACKGROUND

The following relates generally to data processing, and more specifically to data classification. Data processing involves manipulating different types of data to achieve desired results, such as extracting additional information and insights. Various forms of data processing include image processing, audio processing, sequence prediction, and text processing. Image processing, for example, may involve enhancing the visual quality of an image or extracting specific information from it.

Data classification is a form of data processing that involves categorizing data into predefined groups based on its characteristics or content. Classification systems analyze input data to identify patterns, features, or attributes that indicate membership in specific categories. Traditional classification approaches rely on rule-based systems, where human experts define explicit criteria for categorizing data. These systems commonly process structured data, such as numerical measurements or standardized text fields. Recently, machine learning techniques have been applied to data classification tasks. Machine learning classifiers learn to identify complex patterns in data through training on labeled examples. These approaches enable classification of unstructured data like natural language text, images, and audio recordings. Machine learning classification systems generate labels that describe characteristics of the input data. The generated labels support various applications, including content filtering, data organization, and automated decision-making.

### SUMMARY

Embodiments of the inventive concepts described herein include systems and methods for creating and executing ad-hoc data classification models. Embodiments are configured to process input data by traversing a policy graph including decision nodes. The policy graph is a graphical representation of a data policy, such as a harm or bias reduction policy. The input data is evaluated at each decision node, terminating at a special node that applies a decision label to the data. Each decision node classifies the input data based on a machine learning classifier associated with the decision node. In some embodiments, the machine learning classifier includes a multimodal large language model (MLLM) configured to evaluate the data against a classification criterion. The decision nodes route the input data based on classification results from their associated machine learning classifiers. Some embodiments are configured to process a natural language representation of a policy and automatically generate a corresponding policy graph. The policy graph may then be used to classify input data according to the policy requirements.

A method, apparatus, non-transitory computer readable medium, and system for data classification are described. One or more aspects of the method, apparatus, non-transitory computer readable medium, and system include obtaining input data and a policy graph, wherein the policy graph includes a decision node indicating a machine learning classifier; generating, using the machine learning classifier, a classification result based on the input data and the decision node; and generating a decision label for the input data based on the classification result.

A method, apparatus, non-transitory computer readable medium, and system for data classification are described. One or more aspects of the method, apparatus, non-transitory computer readable medium, and system include obtaining an input prompt comprising a natural language classification policy; generating, using a language generation model, a structured policy object based on the input prompt; and generating a policy graph based on the structured policy object that includes a decision node indicating a machine learning classifier.

An apparatus, system, and method for data classification are described. One or more aspects of the apparatus, system, and method include a memory component; a processing device coupled to the memory component, the processing device configured to perform operations comprising; obtaining input data and a policy graph, wherein the policy graph includes a decision node indicating a machine learning classifier; generating, using the machine learning classifier, a classification result based on the input data and the decision node; and generating a decision label for the input data based on the classification result.

### BRIEF DESCRIPTION OF THE DRAWINGS

FIG. 1 shows an example of a data policy system according to aspects of the present disclosure.

FIG. 2 shows an example of a data policy apparatus according to aspects of the present disclosure.

FIG. 3 shows an example of a transformer architecture according to aspects of the present disclosure.

FIG. 4 shows an example of generating a policy graph according to aspects of the present disclosure.

FIG. 5 shows an example of decision node interpretation according to aspects of the present disclosure.

FIG. 6 shows an example of a visual representation of a policy graph according to aspects of the present disclosure.

FIG. 7 shows an example of evaluation results using a policy graph according to aspects of the present disclosure.

FIG. 8 shows an example of data analytics for classifying an input image according to aspects of the present disclosure.

FIG. 9 shows an example of a method for generating a decision label for input data according to aspects of the present disclosure.

FIG. 10 shows an example of a machine learning model training algorithm according to aspects of the present disclosure.

FIG. 11 shows an example of a computing device according to aspects of the present disclosure.

### DETAILED DESCRIPTION

Data classification is a process of analyzing data and assigning labels to the data. For example, a classification system may process input data to determine characteristics of the data. Data classification includes generating labels that indicate the determined characteristics. In some cases, the labels are used to create training datasets. In other cases, the labels control program behavior. For example, a system may block data transmission when a classification label indicates harmful content. Data classification implements policy by determining whether data complies with rules. In some cases, data classification prevents non-compliant data from being processed by machine learning models. In other cases, data classification prevents non-compliant output from being provided to users. For example, a classification system may process text data, image data, video data, or audio data. In some cases, multiple classification operations are performed on a single piece of data.

Data classification systems are frequently used to implement data policies. A data policy is a set of rules that define requirements for data handling, such as content restrictions or quality standards. Typical approaches for automatically enforcing data policies involve building custom classification systems for each policy requirement. These custom systems often require significant engineering resources to develop and maintain. For example, implementing a new content restriction policy may require developing new classification models, integrating external classification services, and creating policy-specific decision logic.

Custom classification systems present several challenges for policy implementation. Each new policy requirement typically requires building additional classification infrastructure. The resulting systems are difficult to modify when policy requirements change. Policy logic is often embedded within application code, making it challenging to update policies without engineering involvement. Additionally, custom systems may implement similar classification logic multiple times across different applications. These limitations make it difficult for users to rapidly deploy and modify data policies in response to new requirements.

Embodiments of the present disclosure increase the efficiency of data classification systems by implementing a unified policy enforcement architecture using interpretable policy graphs. A data policy apparatus processes input data according to decision nodes arranged in a policy graph structure. The policy graph represents classification logic as an ordered sequence of decision operations, where each decision node leverages one or more machine learning classifiers to evaluate input data. For example, a decision node may employ a multimodal large language model to classify input data against specific policy criteria, such as determining the presence of particular content types or characteristics in the data.

The policy graph structure enables rapid deployment of custom data policy models without requiring development of new classification infrastructure. Users modify existing policy graphs or create new policy graphs to implement updated policy requirements. The policy graph maintains separation between policy logic and the underlying classification systems. Some embodiments generate policy graphs from natural language policy descriptions, enabling non-technical users to create and modify data policies. The resulting policy models are scalable across different applications while maintaining consistent policy enforcement. Users can edit the policy graph by interacting with a visual representation of the policy graph via a user interface. The policy graph may integrate multiple machine learning classifiers, including multimodal large language models, custom classifiers, and external classification services.

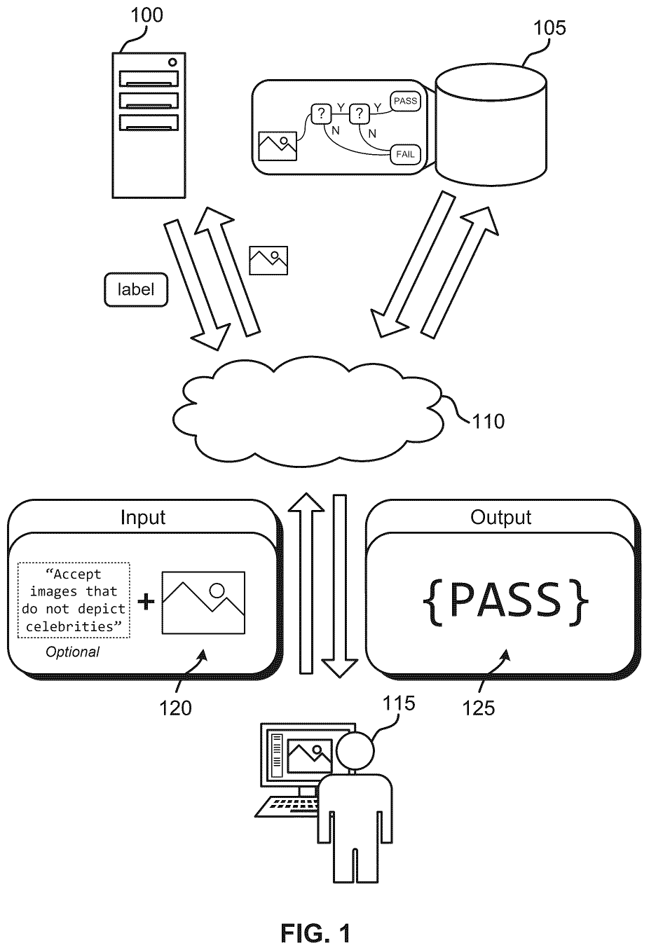

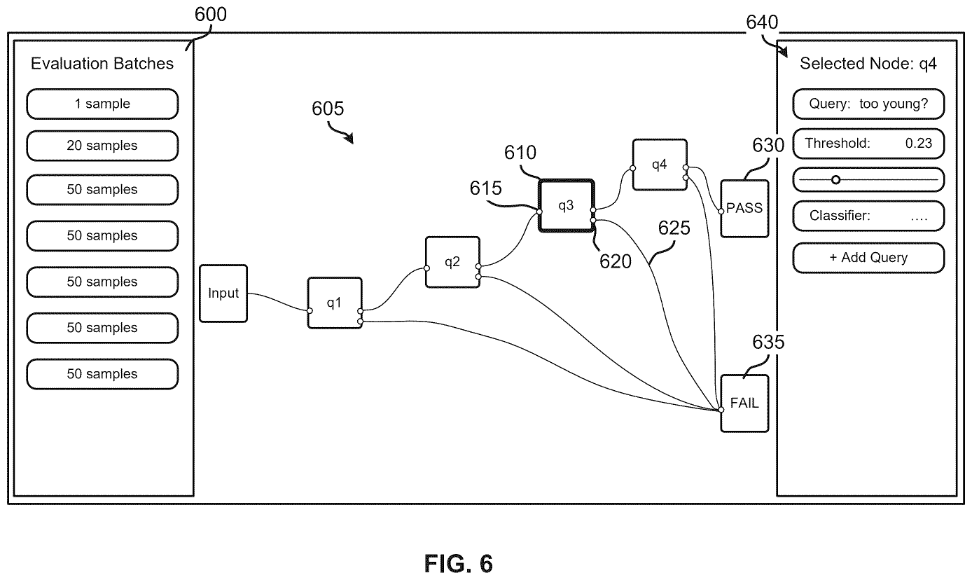

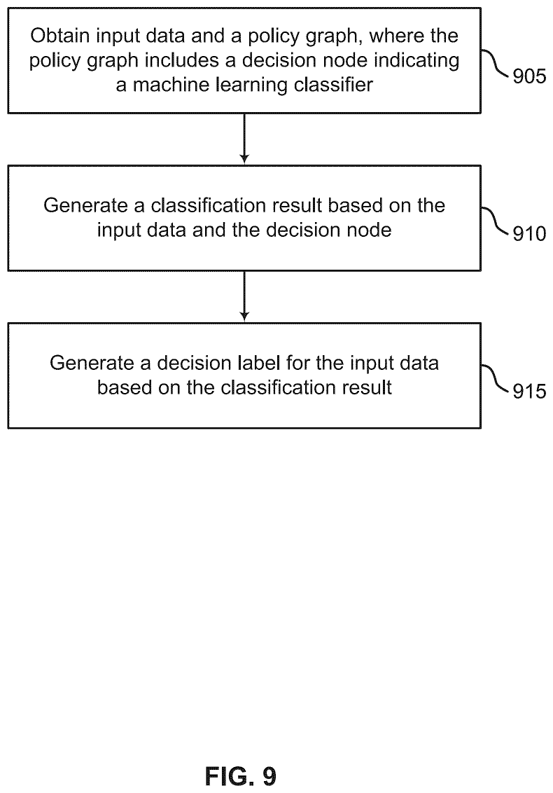

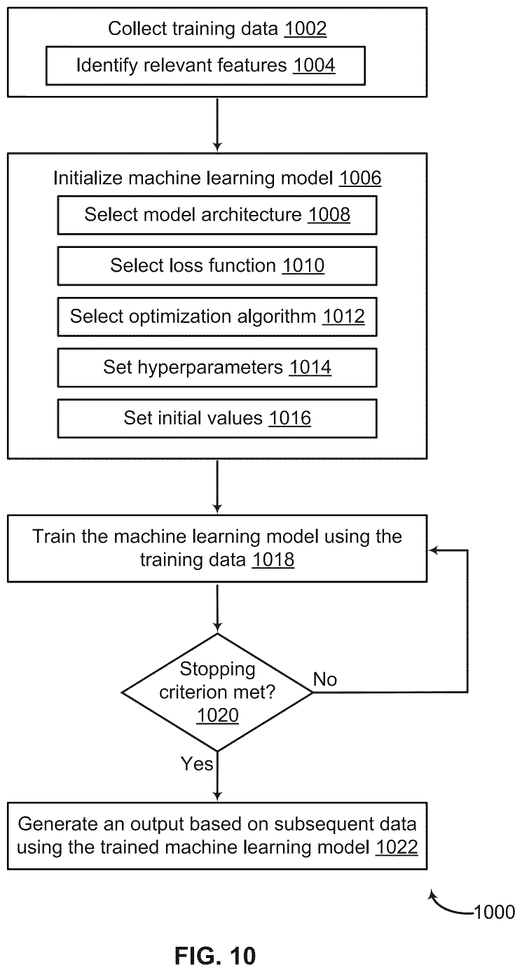

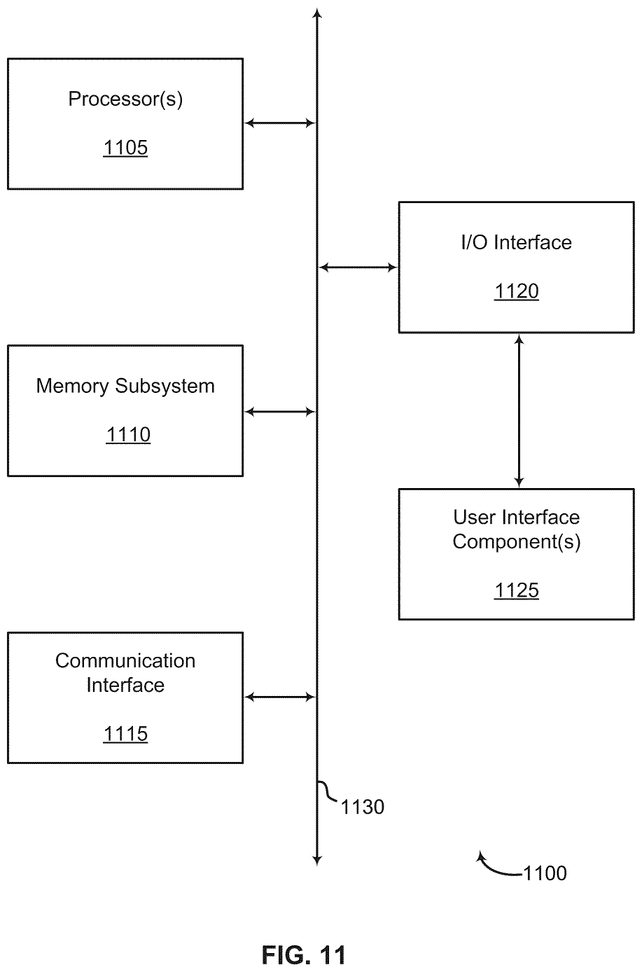

A data policy system is described with reference to FIGS. 1-5. Examples of user interfaces displaying a policy graph is provided with reference to FIGS. 6-8. A method for data classification is described with reference to FIG. 9. A method for training a machine learning model with the data classified by embodiments is described with reference to FIG. 10. A computing device configured to implement a data policy apparatus is described with reference to FIG. 11.

### Data Policy System

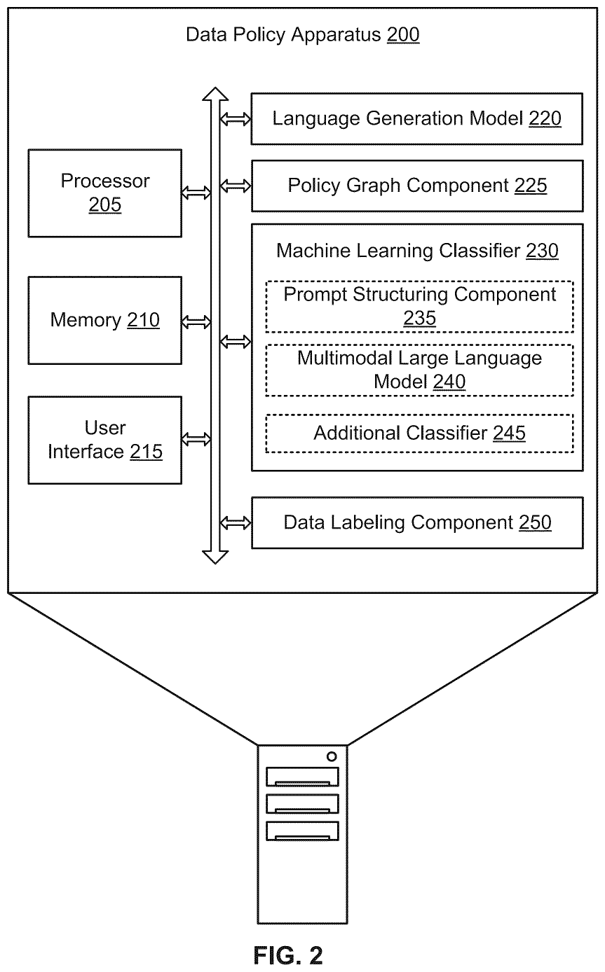

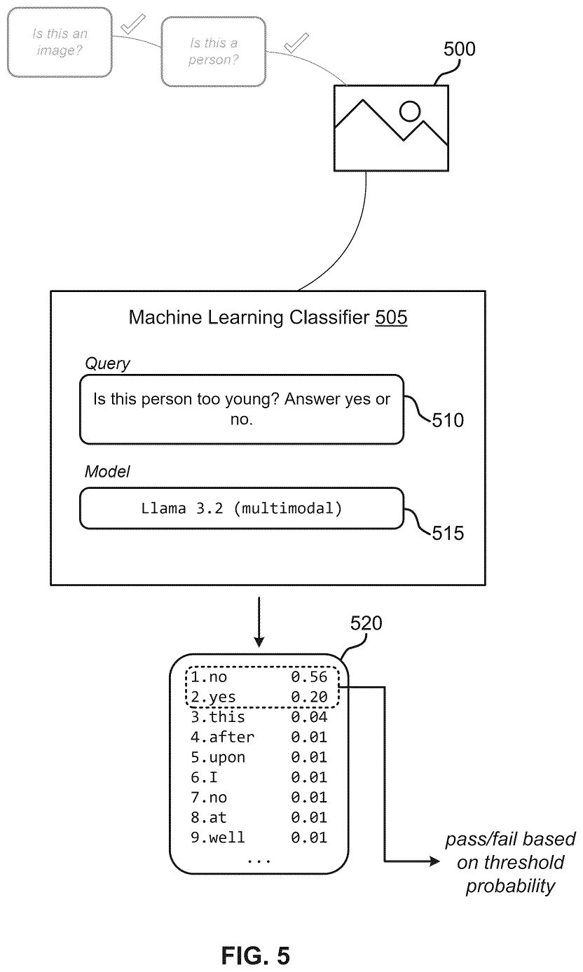

FIG. 1 shows an example of a data policy system according to aspects of the present disclosure. The example shown includes data policy apparatus 100, database 105, network 110, user 115, input data 120, and classification 125. Data policy apparatus 100 is an example of, or includes aspects of, the corresponding element described with reference to FIG. 2. Input data 120 is an example of, or includes aspects of, the corresponding element described with reference to FIG. 5.

In an example process, user 115 provides input data 120 to the system for classification. Input data 120 may be any data, including a generative prompt or some other text, an image, audio, or video. Then, data policy apparatus 100 evaluates the data using a policy graph. In some cases, user 115 provides a data policy of arbitrary complexity in natural language, and the data policy apparatus 100 generates the policy graph therefrom. After evaluation, data policy apparatus 100 returns classification 125, which is a label for input data 120.

Embodiments of data policy apparatus 100 are implemented in whole or in part on a server. A server provides one or more functions to users linked by way of one or more of various networks, such as network 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 stores information used by the data policy system, such as machine learning classifier model parameters, previously generated or constructed policy graphs, unclassified datasets, classified datasets, and the like. A database is an organized collection of data. For example, database 105 may store data in a specified format known as a schema. A database may be structured as a single database, a distributed database, multiple distributed databases, or an emergency backup database. In some cases, a database controller may manage data storage and processing in a database 105. In some cases, user 115 interacts with database 105 via the database controller. In other cases, the database controller may operate automatically without user interaction.

Network 110 facilitates the transfer of information between data policy apparatus 100, database 105, and user 115. Network 110 is sometimes referred to as a “cloud.” A cloud is a computer network configured to provide on-demand availability of computer system resources, such as data storage and computing power. In some examples, the cloud provides resources without active management by user 115. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of a data policy apparatus 200 according to aspects of the present disclosure. The example shown includes data policy apparatus 200, processor 205, memory 210, user interface 215, language generation model 220, policy graph component 225, machine learning classifier 230, and data labeling component 250.

Processor 205 is an intelligent hardware device, (e.g., a general-purpose processing component, a digital signal processor 205 (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 205 is configured to operate memory 210 array using a memory controller. In other cases, a memory controller is integrated into processor 205. In some cases, processor 205 is configured to execute computer-readable instructions stored in memory 210 to perform various functions. In some embodiments, processor 205 includes special purpose components for modem processing, baseband processing, digital signal processing, or transmission processing.

Memory 210 stores data, code, model parameters, and other information used by data policy apparatus 200. Examples of a memory device include random access memory (RAM), read-only memory (ROM), or a hard disk. Examples of memory devices include solid state memory and a hard disk drive. In some examples, memory 210 is used to store computer-readable, computer-executable software including instructions that, when executed, cause processor 205 to perform various functions described herein. In some cases, memory 210 contains, among other things, a basic input/output system (BIOS) which controls basic hardware or software operation such as the interaction with peripheral components or devices. In some cases, a memory controller operates memory cells of memory 210. For example, the memory controller can include a row decoder, column decoder, or both. In some cases, memory cells within memory 210 store information in the form of a logical state.

User interface 215 enable a user to interact with a data policy apparatus 200. In some embodiments, the user interface includes an audio device, such as an external speaker system, an external display device such as a display screen, or an input device (e.g., remote control device interfaced with user interface 215 directly or through an IO controller module). In some cases, user interface 215 may be a graphical user interface (GUI). Additional examples of such a GUI are described with reference to FIGS. 6-8.

Language generation model 220 is a machine learning model that generates text output. For example, language generation model 220 may process input text as a sequence of tokens. Language generation model 220 predicts subsequent tokens based on previously generated tokens as well as one or more input prompts. In some cases, language generation model 220 is configured to process multiple input modalities. The language generation model 220 may generate output text in response to a prompt. In some cases, the language generation model 220 generates text one token at a time. In other cases, the language generation model 220 may generate multiple tokens in parallel. Embodiments of language generation model 220 are used to translate a data policy dictated in natural language into machine-interpretable code. In some embodiments, the outputs of language generation model 220 are constrained using context-free grammars (CFGs).

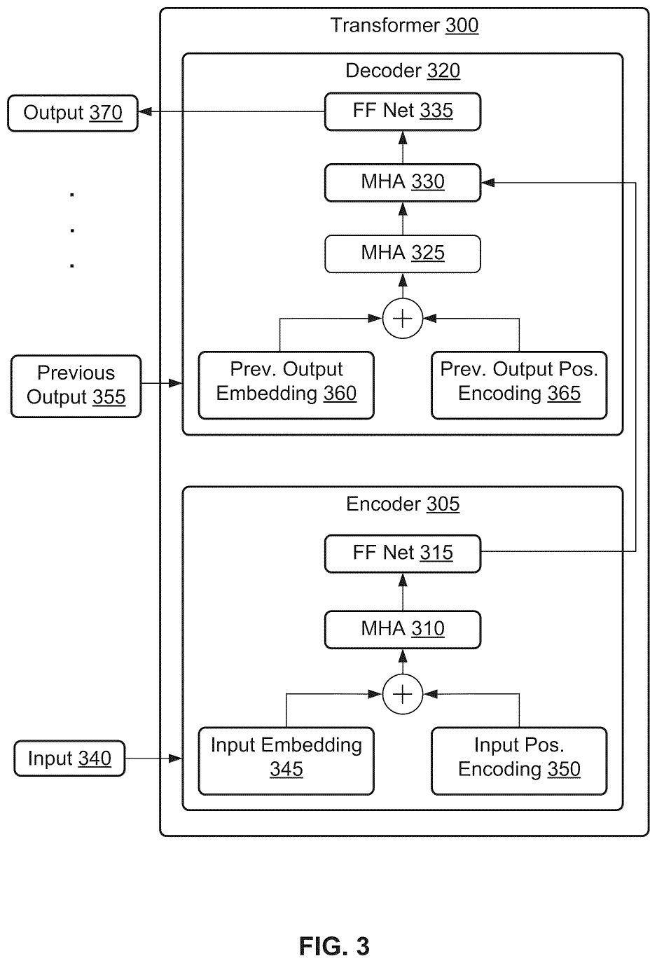

In some cases, language generation model 220 processes input using transformer operations and attention mechanisms. A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a. A transformer architecture is described in detail with reference to FIG. 3.

Policy graph component 225 manages one or more policy graphs within data policy apparatus 200. A graph is a data structure comprising nodes connected by edges. A policy graph is a graph that generates a decision label for input data. For example, a policy graph includes one or more decision nodes. A decision node processes input data and generates classification results as outputs. A decision node is associated with a machine learning classifier. For example, machine learning classifier 230 may be a multimodal large language model, the same as or different than language generation model 220. A policy graph assigns a decision label to input data based on the data's path through the graph. In some cases, a policy graph is an acyclic directed graph. For example, the policy graph may be structured as a binary decision tree. A decision node may include two or more outputs corresponding to different classification results. A policy graph may include multiple decision nodes arranged in sequence. In some cases, each decision node processes results from previous decision nodes in the sequence.

Embodiments of policy graph component 225 are configured to translate a structured policy object including code into a policy graph representation. The policy graph may include a decision node indicating a machine learning classifier. In some aspects, the policy graph includes a directed acyclic graph including a set of decision nodes including the decision node indicating the machine learning classifier 230. In some aspects, the policy graph includes a binary tree.

In some examples, policy graph component 225 edits the policy graph based on an edit command received from a user. In some cases, policy graph component 225 updates the policy graph based on user edits to the structured policy object, edits made using a GUI depicting a visualization of the policy graph, or both. In some aspects, the policy graph includes an edge corresponding to the classification result and connected to the decision node, where the decision label is generated based on the edge.

In one aspect, machine learning classifier 230 includes prompt structuring component 235, multimodal large language model 240, and additional classifier 245. learning classifier 230 processes input data to generate classification results. Machine learning classifier 230 may include one or more classification models. For example, machine learning classifier 230 may include multimodal large language model 240, additional classifier 245, or both. In some cases, machine learning classifier 230 includes a single classifier. In other cases, machine learning classifier 230 includes multiple classifiers operating in sequence or in parallel. Machine learning classifier 230 receives input data and classification parameters from a decision node. The classification parameters specify how machine learning classifier 230 evaluates the input data. Machine learning classifier 230 generates classification results based on the evaluation. For example, machine learning classifier 230 generates a probability distribution over possible classification outcomes. In some cases, machine learning classifier 230 compares the probability distribution to one or more thresholds to determine the classification result.

In some examples, machine learning classifier 230 includes multimodal large language model 240. Multimodal large language model 240 processes text data, image data, video data, or audio data. Multimodal large language model 240 generates a token probability distribution based on the input data. The token probability distribution indicates probabilities for different classification outcomes. For example, multimodal large language model 240 processes input data and classification criteria to determine whether specific characteristics are present in the input data. In some cases, multimodal large language model 240 processes multiple input modalities simultaneously to generate the classification result. In some embodiments, the classification result includes a probability distribution of next-token probabilities, where the next-token probabilities are determined based on the input data and a query provided by prompt structuring component 235.

A multimodal large language model is a machine learning model that processes multiple types of input data. For example, a multimodal large language model processes text data alongside image data, video data, or audio data. In some examples, multimodal large language models operate on a unified embedding space capable of representing different modalities of information. For example, tokens representing different modalities may be tagged according to their modality to signal the underlying model. A multimodal large language model generates text output based on processing the multiple input modalities. In some cases, a multimodal large language model generates a probability distribution over possible next tokens. The probability distribution indicates likelihood scores for different outputs based on the input data.

According to some aspects, machine learning classifier 230 generates a classification result based on input data and a decision node. In some examples, machine learning classifier 230 encodes the input data to obtain a set of token embeddings. In some examples, machine learning classifier 230 generates a token probability distribution based on the set of token embeddings, where the classification result is based on the token probability distribution. In some examples, machine learning classifier 230 performs an autoregressive token prediction. Machine learning classifier 230 is an example of, or includes aspects of, the corresponding element described with reference to FIG. 5.

According to some aspects, data labeling component 250 generates a decision label for the input data based on the classification result. Data labeling component 250 processes batches of input data samples using a policy graph. For each sample in a batch, data labeling component 250 simulates the sample's path through the policy graph. The path includes one or more decision nodes that generate classification results. Data labeling component 250 determines subsequent decision nodes based on each classification result. For example, data labeling component 250 follows edges in the policy graph corresponding to the classification results. Data labeling component 250 assigns a decision label to each sample based on its path through the policy graph. In some cases, data labeling component 250 stores the decision labels with the corresponding samples. In other cases, data labeling component 250 provides the labeled samples to other components for further processing.

FIG. 3 shows an example of a transformer network according to aspects of the present disclosure. The example shown includes transformer 300, encoder 305, decoder 320, input 340, input embedding 345, input positional encoding 350, previous output 355, previous output embedding 360, previous output positional encoding 365, and output 370.

In some cases, encoder 305 includes multi-head self-attention sublayer 310 and feed-forward network sublayer 315. In some cases, decoder 320 includes first multi-head self-attention sublayer 325, second multi-head self-attention sublayer 330, and feed-forward network sublayer 335.

According to some aspects, a machine learning model (such as the machine learning classifier described with reference to FIG. 2) comprises transformer 300. In some cases, encoder 305 is configured to map input 340 (for example, a query or a prompt comprising a sequence of words or tokens) to a sequence of continuous representations that are fed into decoder 320. In some cases, decoder 320 generates output 370 (e.g., a prediction of an output sequence of words or tokens) based on the output of encoder 305 and previous output 355 (e.g., a previously predicted output sequence), which allows for the use of autoregression.

For example, in some cases, encoder 305 parses input 340 into tokens and vectorizes the parsed tokens to obtain input embedding 345, and adds input positional encoding 350 (e.g., positional encoding vectors for input 340 of a same dimension as input embedding 345) to input embedding 345. In some cases, input positional encoding 350 includes information about relative positions of words or tokens in input 340.

In some cases, encoder 305 comprises one or more encoding layers (e.g., six encoding layers) that generate contextualized token representations, where each representation corresponds to a token that combines information from other input tokens via self-attention mechanism. In some cases, each encoding layer of encoder 305 comprises a multi-head self-attention sublayer (e.g., multi-head self-attention sublayer 310). In some cases, the multi-head self-attention sublayer implements a multi-head self-attention mechanism that receives different linearly projected versions of queries, keys, and values to produce outputs in parallel. In some cases, each encoding layer of encoder 305 also includes a fully connected feed-forward network sublayer (e.g., feed-forward network sublayer 315) comprising two linear transformations surrounding a Rectified Linear Unit (ReLU) activation:

$$F F N ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁,b₂) to apply a same linear transformation to each word or token in input 340.

In some cases, each sublayer of encoder 305 is followed by a normalization layer that normalizes a sum computed between a sublayer input x and an output sublayer(x) generated by the sublayer:

$$layernorm ( x + sublayer ( x ) ) \qquad ( 2 )$$

In some cases, encoder 305 is bidirectional because encoder 305 attends to each word or token in input 340 regardless of a position of the word or token in input 340.

In some cases, decoder 320 comprises one or more decoding layers (e.g., six decoding layers). In some cases, each decoding layer comprises three sublayers including a first multi-head self-attention sublayer (e.g., first multi-head self-attention sublayer 325), a second multi-head self-attention sublayer (e.g., second multi-head self-attention sublayer 330), and a feed-forward network sublayer (e.g., feed-forward network sublayer 335). In some cases, each sublayer of decoder 320 is followed by a normalization layer that normalizes a sum computed between a sublayer input x and an output sublayer(x) generated by the sublayer.

In some cases, decoder 320 generates previous output embedding 360 of previous output 355 and adds previous output positional encoding 365 (e.g., position information for words or tokens in previous output 355) to previous output embedding 360. In some cases, each first multi-head self-attention sublayer receives the combination of previous output embedding 360 and previous output positional encoding 365 and applies a multi-head self-attention mechanism to the combination. In some cases, for each word in an input sequence, each first multi-head self-attention sublayer of decoder 320 attends only to words preceding the word in the sequence, and so transformer 300's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 305 by receiving a query Q from a previous sublayer of decoder 320 and a key K and a value V from the output of encoder 305, allowing decoder 320 to attend to each word in the input 340.

In some cases, each feed-forward network sublayer implements a fully connected feed-forward network similar to feed-forward network sublayer 315. In some cases, the feed-forward network sublayers are followed by a linear transformation and a softmax function to generate a prediction of output 370 (e.g., a prediction of a next word or token in a sequence of words or tokens). According to some aspects, this prediction of a next word or token is generated in the form of a probability distribution over a token vocabulary, and this probability distribution is used utilized directly by embodiments herein as the “classification result” of a decision node.

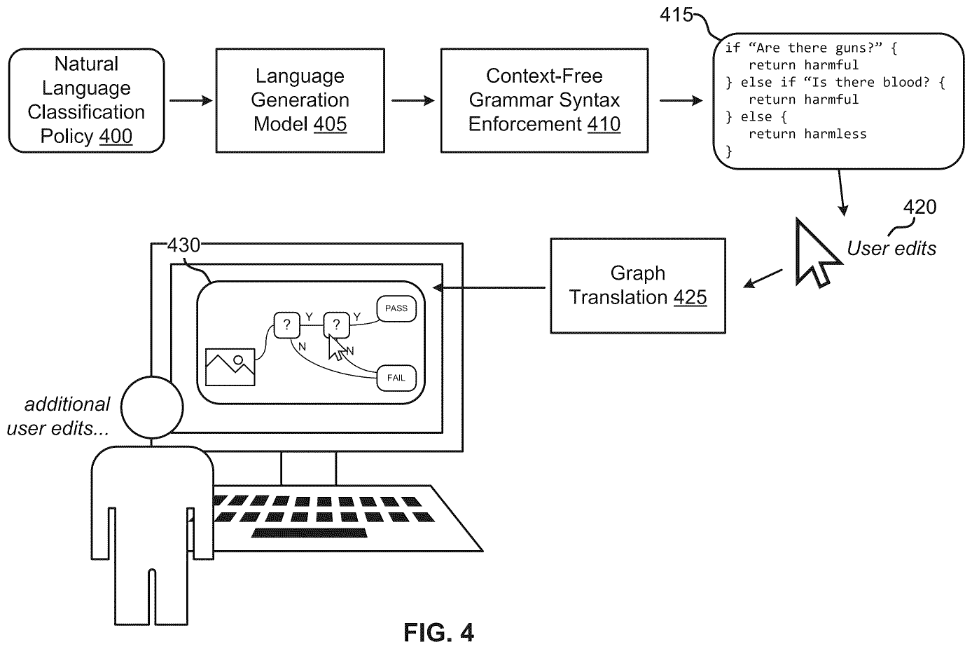

FIG. 4 shows an example of generating a policy graph 430 according to aspects of the present disclosure. The example shown includes natural language classification policy 400, language generation model 405, context-free grammar syntax enforcement 410, structured policy object 415, user edits 420, graph translation 425, and policy graph 430.

Language generation model 405 is an example of, or includes aspects of, the corresponding element described with reference to FIG. 2. Policy graph 430 is an example of, or includes aspects of, the corresponding element described with reference to FIGS. 6-8.

Natural language classification policy 400 includes a textual description of classification rules. For example, natural language classification policy 400 includes human-readable text describing conditions and actions for data classification. Language generation model 405 processes natural language classification policy 400 to generate code representing classification rules.

According to some aspects, language generation model 405 outputs raw logit scores for each potential token in generation sequence. Context-free grammar syntax enforcement 410 constrains language generation model 405 output to ensure syntactic validity. In some embodiments, context-free grammar syntax enforcement 410 applies a mask to raw logit scores output by language generation model 405. For example, context-free grammar syntax enforcement 410 may set logit scores for invalid tokens to negative infinity based on grammar rules. Accordingly, context-free grammar syntax enforcement 410 ensures generated code conforms to predefined syntax specification.

Structured policy object 415 includes generated code representing classification rules. Structured policy object 415 may include formal syntax elements defining classification logic. For example, structured policy object 415 contains parse-able code describing decision nodes and classification paths. At this point, a user may provide user edits 420 to the code within structured policy object 415 to influence the final policy graph.

Graph translation 425 converts structured policy object 415 into graph representation. Graph translation 425 processes formal code to generate nodes and edges. For example, graph translation 425 creates decision nodes based on classification rules and connects nodes based on logic flow from structured policy object 415. Embodiments of graph translation 425 may assign one or more default machine learning classifiers (e.g., as described with reference to FIG. 2) to each decision node.

Policy graph 430 represents the final graph structure for performing a classification. Policy graph 430 includes decision nodes connected by edges representing classification paths. For example, policy graph 430 comprises directed acyclic graph where each node represents classification decision point. Accordingly, embodiments are configured to implement an ad-hoc classification model for any classification task, such as harm or bias reduction of data, by generating policy graph 430. Embodiments may evaluate batches of input data using policy graph 430 to classify the input data for suitable use in training datasets, or display to particular audiences.

FIG. 5 shows an example of decision node interpretation according to aspects of the present disclosure. The example shown includes input data 500, machine learning classifier 505, and output probabilities 520. In one aspect, machine learning classifier 505 includes data query 510 and selected classification model 515. Input data 500 is an example of, or includes aspects of, the corresponding element described with reference to FIG. 1. Machine learning classifier 505 is an example of, or includes aspects of, the corresponding element described with reference to FIG. 2.

FIG. 5 illustrates decision node interpretation in a policy graph. The example shows processing flow from previous decision nodes through a classification decision. In this example, previous decision nodes evaluate preliminary classification conditions such as media type detection and subject identification. For example, preceding nodes may determine whether input data contains an image and whether the image contains a person.

Input data 500 flows from previous decision node results into machine learning classifier 505. Machine learning classifier 505 may be associated with a decision node within a policy graph configured to evaluate specific classification criteria. The classification criteria may be associated with, for example, a data policy. For example, the data policy considered in this example may be to ‘pass’ images of persons that are not too young and reject all other data instances.

Machine learning classifier 505 includes configurable components for classification processing. Data query 510 provides an editable text field containing a natural language query to guide classification. For example, data query 510 may contain text “Is this person too young?Answer yes or no.” Selected classification model 515 provides a dropdown interface for choosing a desired machine learning model for classification. In some aspects, data query 510 functionality depends on selected classification model 515. For example, when a non-multimodal classification model is selected in selected classification model 515, data query 510 may become inactive and appear grayed out in the interface.

Output probabilities 520 displays classification results as a ranked list of potential output tokens and their associated probabilities. For example, output probabilities 520 shows token “no” with 0.56 probability and token “yes” with 0.20 probability. A classification decision is determined by comparing these probabilities against predefined thresholds. Embodiments may implement pass/fail classification decisions based on probability thresholds applied to output probabilities 520. For example, a decision node may select a path in the policy graph when a token probability exceeds a specified threshold value. Some embodiments perform probability renormalization over a subset of n tokens (e.g., n=2) to obtain normalized binary probabilities:

$$\frac{No = 0.56}{Yes = 0.2 + No = 0.56} = 0.74 for No \qquad ( 3 )$$

For example, normalizing probabilities for tokens “no” (0.56) and “yes” (0.20) yields a normalized probability of 0.74 for token “no”.

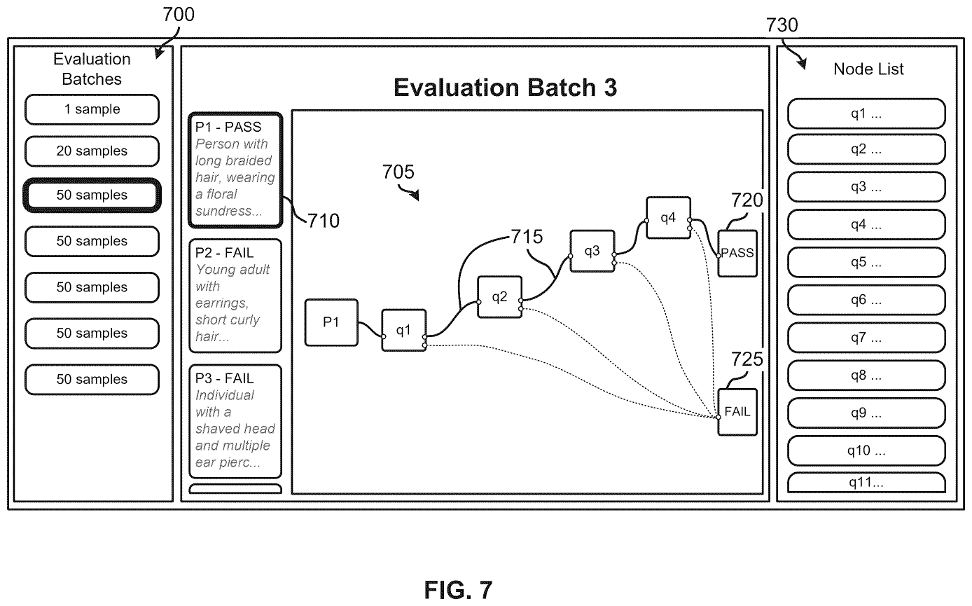

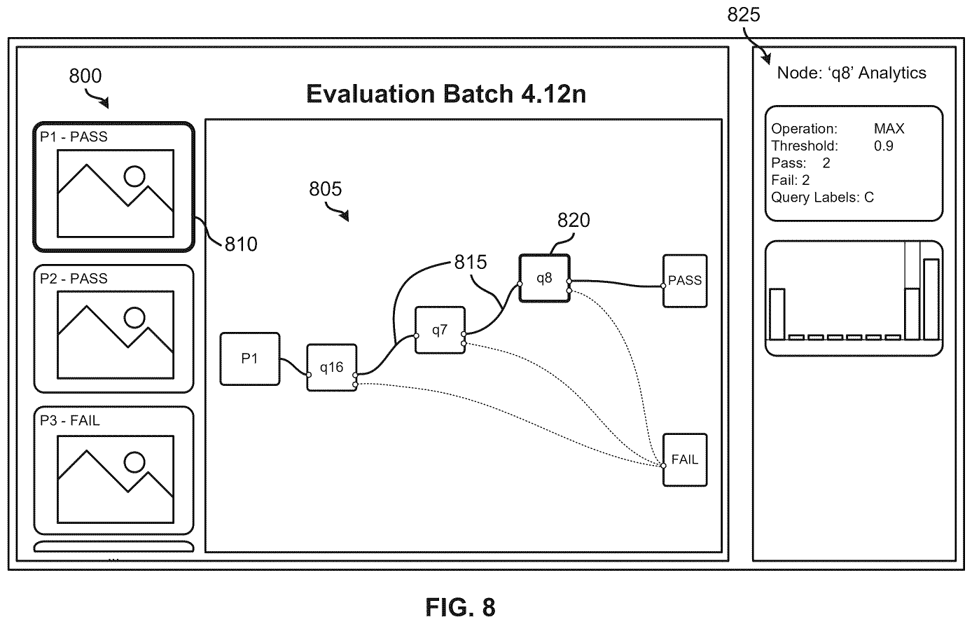

FIG. 6 shows an example of a visual representation of a policy graph 605 according to aspects of the present disclosure. The example shown includes evaluation batch window 600, policy graph 605, decision node 610, edge 625, first decision label 630, second decision label 635, and decision node control window 640. Evaluation batch window 600 is an example of, or includes aspects of, the corresponding element described with reference to FIGS. 7 and 8. Policy graph 605 is an example of, or includes aspects of, the corresponding element described with reference to FIGS. 4, 7, and 8. First decision label 630 is an example of, or includes aspects of, the corresponding element described with reference to FIG. 7. Second decision label 635 is an example of, or includes aspects of, the corresponding element described with reference to FIG. 7.

Evaluation batch window 600 displays available batches of generation prompts for policy evaluation. In this example, embodiments are evaluating prompts (e.g., user generated prompts), rather than media such as generated images or videos. Each batch contains multiple prompts to be evaluated against policy graph 605 for potential issues such as harmful or biased content. When no batch is selected, evaluation batch window 600 shows only the list of available batches.

Embodiments display a visual representation of a policy as policy graph 605, which includes interconnected decision nodes. Policy graph 605 processes input data through a sequence of classification decisions to determine appropriate decision labels. Decision node 610 represents a single classification unit within policy graph 605. For example, the classification unit may include a machine learning classifier as described with reference to FIGS. 2 and 5.

Input port 615 receives data flow from previous decision nodes through incoming edges. Output port 620 connects to subsequent nodes through edge 625, which represents a specific classification result. For example, edge 625 may indicate whether input data passed or failed a particular classification criterion.

Edge 625 carries input data between decision nodes based on classification results. Each edge represents a distinct classification outcome that determines the subsequent processing path through policy graph 605.

First decision label 630 and second decision label 635 represent terminal nodes in policy graph 605. These nodes contain no classification logic but assign final classification labels to input data based on traversal paths through policy graph 605.

Decision node control window 640 provides an interface for configuring selected decision nodes. For example, decision node control window 640 enables editing of classification queries and selection of machine learning models as described with reference to FIG. 5.

FIG. 7 shows an example of evaluation results using a policy graph 705 according to aspects of the present disclosure. The example shown includes evaluation batch window 700, policy graph 705, selected data 710, path of selected data 715, first decision label 720, second decision label 725, and decision node list 730. Evaluation batch window 700 is an example of, or includes aspects of, the corresponding element described with reference to FIGS. 6 and 8. Policy graph 705 is an example of, or includes aspects of, the corresponding element described with reference to FIGS. 4, 6, and 8.

Selected data 710 is an example of, or includes aspects of, the corresponding element described with reference to FIG. 8. Path of selected data 715 is an example of, or includes aspects of, the corresponding element described with reference to FIG. 8. First decision label 720 and second decision label 725 represent terminal classification outcomes as described with reference to FIG. 6. Description of repeated elements may be omitted for brevity. Detailed descriptions of corresponding elements may be found throughout the Specification.

Evaluation batch window 700 displays an active batch selection with associated generation prompts. Selection of a batch expands evaluation batch window 700 to show individual prompts for evaluation. Selected data 710 represents a single prompt selected from the active batch in evaluation batch window 700. When a prompt is selected, path of selected data 715 highlights the traversal path through policy graph 705 by increasing the thicknesses of the edges of the path. Path of selected data 715 traces the sequence of classification decisions applied to selected data 710.

Decision node list 730 provides an inventory of available decision nodes for incorporation into policy graph 705. Each decision node in decision node list 730 may be associated with a specific classification variable. For example, available nodes may include classifications such as “is_human” or “is_child”. Embodiments accordingly enable interactive visualization of classification processes by displaying actual data traversal through policy graph 705. This visualization helps users understand and verify classification decisions for specific input data.

FIG. 8 shows an example of data analytics for classifying an input image according to aspects of the present disclosure. The example shown includes evaluation batch window 800, policy graph 805, selected data 810, path of selected data 815, selected decision node 820, and decision node analytics window 825. Evaluation batch window 800 is an example of, or includes aspects of, the corresponding element described with reference to FIGS. 6 and 7. Description of repeated elements may be omitted for brevity. Detailed descriptions of corresponding elements may be found throughout the Specification.

Evaluation batch window 800 displays a selected batch of images for classification analysis. According to some aspects, the selected batch may be associated with a previously saved policy graph, which will update the currently displayed policy graph 805.

Policy graph 805 implements classification logic adapted for image processing through interconnected decision nodes. Selected data 810 represents an individual image chosen from the active batch, with path of selected data 815 highlighting its classification path through policy graph 805. Selected decision node 820 enables detailed analysis of classification behavior across the entire batch. Decision node analytics window 825 displays aggregate statistics and individual classification metrics for selected decision node 820. For example, decision node analytics window 825 shows: operation type configurations (e.g., MAX), threshold values for classification decisions (e.g., 0.9), aggregate statistics including pass/fail counts for the batch, and distribution analytics for selected data within the batch. Accordingly, embodiments enable informed user optimizations for policies. Users may analyze classification patterns across demographic groups, evaluate classification model performance characteristics, visualize individual datum positions within the classification distribution, and adjust classification thresholds based on observed patterns.

FIG. 9 shows an example of a method 900 for generating a decision label for input data according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, the system obtains input data and a policy graph, where the policy graph includes a decision node indicating a machine learning classifier. In some cases, the operations of this step refer to, or may be performed by, a data policy apparatus as described with reference to FIGS. 1 and 2. The input data may be any information for evaluation in accordance with a policy. Examples of input data include but are not limited to texts, user-provided prompts, generated images, videos, audio, and natural images, videos, and audio. The policy graph may be stored in a database and represent a data policy that includes a set of rules for the data to be evaluated. Alternatively, the policy graph may be generated by the system from a natural language description of the policy.

At operation 910, the system generates a classification result based on the input data and the decision node. In some cases, the operations of this step refer to, or may be performed by, a machine learning classifier as described with reference to FIGS. 2 and 5. The machine learning classifier is not particularly limited but may include a multimodal large language model (MLLM) configured to process the input data and a query regarding the input data, and to output a response based on the input data and the query. The classification result may be, but is not limited to, a next-token probability distribution.

At operation 915, the system generates a decision label for the input data based on the classification result. In some cases, the operations of this step refer to, or may be performed by, a data labeling component as described with reference to FIG. 2. The decision label may be generated based on the termination point of the input data's path through the policy graph. For example, the classification result may determine which edge the input data traverses from the decision node, where the sequence of these traversals leads to a terminal node associated with a specific decision label. The decision label may indicate whether the input data satisfies policy requirements, such as content safety criteria or demographic fairness metrics. The system may store the decision label in association with the input data for subsequent use in training dataset curation or content filtering applications.

FIG. 10 is a flow diagram depicting an algorithm as a step-by-step procedure 1000 in an example implementation of operations performable for training a machine-learning model. Embodiments described herein are configured to label input data according to a set of decisions outlined in a policy graph. The labeled data may be used for training generative models and reinforcement learning models. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (block 1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore, once trained is configured to perform that task based on subsequent data received as an input and processed by the machine-learning model.

FIG. 11 shows an example of a computing device 1100 according to aspects of the present disclosure. The example shown includes computing device 1100, processor(s) 1105, memory subsystem 1110, communication interface 1115, I/O interface 1120, user interface component(s), and channel 1130.

In some embodiments, computing device 1100 is an example of, or includes aspects of, a data policy apparatus as described in FIGS. 1 and 2. In some embodiments, computing device 1100 includes one or more processors 1105 are configured to execute instructions stored in memory subsystem 1110 to obtain input data and a policy graph, wherein the policy graph includes a decision node indicating a machine learning classifier; generate, using the machine learning classifier, a classification result based on the input data and the decision node; and generate a decision label for the input data based on the classification result.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 2225 include a GUI.

Accordingly, the present disclosure includes the following aspects.

A method for data classification is described. One or more aspects of the method include obtaining input data and a policy graph, wherein the policy graph includes a decision node indicating a machine learning classifier; generating, using the machine learning classifier, a classification result based on the input data and the decision node; and generating a decision label for the input data based on the classification result.

In some aspects, the policy graph comprises a directed acyclic graph comprising a plurality of decision nodes including the decision node indicating the machine learning classifier. In some aspects, the policy graph comprises a binary tree. In some aspects, the policy graph includes an edge corresponding to the classification result and connected to the decision node, wherein the decision label is generated based on the edge.

Some examples of the method, apparatus, non-transitory computer readable medium, and system further include generating, using another machine learning classifier different from the machine learning classifier of the decision node, a subsequent classification result based on the classification result and another decision node of the policy graph. Some examples further include encoding the input data to obtain a plurality of token embeddings. Some examples further include generating a token probability distribution based on the plurality of token embeddings, wherein the classification result is based on the token probability distribution. Some examples further include performing an autoregressive token prediction. Some examples further include displaying a visualization of the policy graph and a path through the policy graph from the input data to the decision label. In some aspects, the decision label is used to train a machine learning model.

A method for data classification is described. One or more aspects of the method include obtaining an input prompt comprising a natural language classification policy; generating, using a language generation model, a structured policy object based on the input prompt; and generating a policy graph based on the structured policy object that includes a decision node indicating a machine learning classifier.

Some examples of the method, apparatus, non-transitory computer readable medium, and system further include performing an autoregressive token prediction. In some aspects, the policy graph comprises a directed acyclic graph comprising a plurality of decision nodes including the decision node indicating the machine learning classifier. In some aspects, the policy graph comprises a binary tree.

Some examples of the method, apparatus, non-transitory computer readable medium, and system further include obtaining an edit command. Some examples further include editing the policy graph based on the edit command. Some examples further include displaying a visualization of the policy graph. Some examples further include receiving a user input indicating the edit command based on the visualization.

An apparatus for data classification is described. One or more aspects of the apparatus include a memory component; a processing device coupled to the memory component, the processing device configured to perform operations comprising; obtaining input data and a policy graph, wherein the policy graph includes a decision node indicating a machine learning classifier; generating, using the machine learning classifier, a classification result based on the input data and the decision node; and generating a decision label for the input data based on the classification result.

Some examples of the apparatus, system, and method further include generating, using another machine learning classifier different from the machine learning classifier of the decision node, a subsequent classification result based on the classification result and another decision node of the policy graph. Some examples further include encoding the input data to obtain a plurality of token embeddings. Some examples further include generating a token probability distribution based on the plurality of token embeddings, wherein the classification result is based on the token probability distribution. In some aspects, the policy graph includes an edge corresponding to the classification result and connected to the decision node, wherein the decision label is generated based on the edge.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining input data and a policy graph, wherein the policy graph includes a decision node indicating a machine learning classifier;
generating, using the machine learning classifier, a classification result based on the input data and the decision node; and
generating a decision label for the input data based on the classification result.

2. The method of claim 1, wherein:
the policy graph comprises a directed acyclic graph comprising a plurality of decision nodes including the decision node indicating the machine learning classifier.

3. The method of claim 2, wherein:
the policy graph comprises a binary tree.

4. The method of claim 1, wherein:
the policy graph includes an edge corresponding to the classification result and connected to the decision node, wherein the decision label is generated based on the edge.

5. The method of claim 1, further comprising:
generating, using another machine learning classifier different from the machine learning classifier of the decision node, a subsequent classification result based on the classification result and another decision node of the policy graph.

6. The method of claim 1, wherein generating the classification result comprises:
encoding the input data to obtain a plurality of token embeddings; and
generating a token probability distribution based on the plurality of token embeddings, wherein the classification result is based on the token probability distribution.

7. The method of claim 1, wherein generating the classification result comprises:
performing an autoregressive token prediction.

8. The method of claim 1, further comprising:
displaying a visualization of the policy graph and a path through the policy graph from the input data to the decision label.

9. The method of claim 1, wherein:
the decision label is used to train a machine learning model.

10. A non-transitory computer readable medium storing code for image processing, the code comprising instructions that, when executed by at least one processor, cause the at least one processor to perform operations comprising:
obtaining an input prompt comprising a natural language classification policy;
generating, using a language generation model, a structured policy object based on the input prompt; and
generating a policy graph based on the structured policy object that includes a decision node indicating a machine learning classifier.

11. The non-transitory computer readable medium of claim 10, wherein generating the structured policy object comprises:
performing an autoregressive token prediction.

12. The non-transitory computer readable medium of claim 10, wherein:
the policy graph comprises a directed acyclic graph comprising a plurality of decision nodes including the decision node indicating the machine learning classifier.

13. The non-transitory computer readable medium of claim 12, wherein:
the policy graph comprises a binary tree.

14. The non-transitory computer readable medium of claim 10, the operations further comprising:
obtaining an edit command; and
editing the policy graph based on the edit command.

15. The non-transitory computer readable medium of claim 14, wherein obtaining the edit command comprises:
displaying a visualization of the policy graph; and
receiving a user input indicating the edit command based on the visualization.

16. The non-transitory computer readable medium of claim 10, wherein:
the policy graph includes an edge corresponding to a classification result from the machine learning classifier and connected to the decision node.

17. A system comprising:
a memory component;
a processing device coupled to the memory component, the processing device configured to perform operations comprising:
obtaining input data and a policy graph, wherein the policy graph includes a decision node indicating a machine learning classifier;
generating, using the machine learning classifier, a classification result based on the input data and the decision node; and
generating a decision label for the input data based on the classification result.

18. The system of claim 17, the processing device further configured to perform operations comprising:
generating, using another machine learning classifier different from the machine learning classifier of the decision node, a subsequent classification result based on the classification result and another decision node of the policy graph.

19. The system of claim 17, the processing device further configured to perform operations comprising:
encoding the input data to obtain a plurality of token embeddings; and
generating a token probability distribution based on the plurality of token embeddings, wherein the classification result is based on the token probability distribution.

20. The system of claim 17, wherein:
the policy graph includes an edge corresponding to the classification result and connected to the decision node, wherein the decision label is generated based on the edge.
